(19) United States
(12) Patent Application Publication
(10) Pub. No.: US 2025/0310795 A1
(43) Pub. Date: Oct. 2, 2025

(54) METHOD AND APPARATUS FOR ARTIFICIAL NEURAL NETWORK POSITIONING IN WIRELESS COMMUNICATION SYSTEMS

(71) Applicant: ELECTRONICS AND TELECOMMUNICATIONS RESEARCH INSTITUTE, Daejeon (KR)

(72) Inventors: Seung Jae BAHNG, Daejeon (KR); Yong Jin KWON, Daejeon (KR); Young Joon YOON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 19/089,513

(22) Filed: Mar. 25, 2025

(30) Foreign Application Priority Data
Mar. 28, 2024 (KR) 10-2024-0042469
Jul. 3, 2024 (KR) 10-2024-0087741
Dec. 17, 2024 (KR) 10-2024-0188563

(51) Int. Cl. H04W 24/02; H04W 24/10; H04W 64/00

(52) U.S. Cl. CPC H04W 24/02; H04W 24/10; H04W 64/003

(57) ABSTRACT

A method performed by a communication device in a wireless communication system, may comprise: receiving capability request information for artificial intelligence/machine learning (AI/ML)-based positioning from a network; and transmitting capability information based on the capability request information, wherein the capability information includes at least one of first information indicating whether the communication device supports AI/ML direct positioning, second information indicating whether the communication device supports AI/ML-assisted positioning, and third information indicating a type of a channel report related to the AI/ML-based positioning.

### CROSS-REFERENCE TO RELATED APPLICATIONS

This application claims priority to Korean Patent Applications No. 10-2024-0042469, filed on Mar. 28, 2024, No. 10-2024-0087741, filed on Jul. 3, 2024, and No. 10-2024-0188563, filed on Dec. 17, 2024, with the Korean Intellectual Property Office (KIPO), the entire contents of which are hereby incorporated by reference.

### BACKGROUND

### 1. Technical Field

The present disclosure relates to a wireless communication system, and more particularly, to a configuration method and apparatus for artificial neural network positioning in a wireless communication system.

### 2. Related Art

The international standardization organization 3GPP has defined AI/ML use cases applicable to the New Radio (NR) wireless interface in Release 18 and has discussed how AI/ML technology can achieve performance improvements through these use cases. These use cases include: (1) Channel State Information (CSI) feedback enhancement, (2) beam management enhancement, and (3) positioning accuracy enhancement. In particular, beam management and positioning accuracy improvement are being defined with specific methodologies and procedures as a work item (WI) in Release 19, while further research is ongoing for the CSI feedback enhancement.

### SUMMARY

The present disclosure for resolving the above-described problems is directed to providing a configuration method and apparatus for artificial neural network positioning in a wireless communication system.

According to a first exemplary embodiment of the present disclosure, a method performed by a communication device in a wireless communication system may comprise: receiving capability request information for artificial intelligence/machine learning (AI/ML)-based positioning from a network; and transmitting capability information based on the capability request information, wherein the capability information includes at least one of first information indicating whether the communication device supports AI/ML direct positioning, second information indicating whether the communication device supports AI/ML-assisted positioning, and third information indicating a type of a channel report related to the AI/ML-based positioning.

Each of the first information and the second information may be configured as boolean data, and the third information may indicate at least one of a channel impulse response (CIR), a delay profile (DP), a power delay profile (PDP), or a sample-based measurement related parameter.

The capability information may be transmitted to a location management function (LMF).

According to a second exemplary embodiment of the present disclosure, a method performed by a communication device in a wireless communication system may comprise: obtaining a first output result of a direct AI/ML positioning model, a second output result of an AI/ML-assisted positioning model, and a non-AI/ML model-based positioning result; and monitoring a performance of the direct AI/ML positioning model by using at least one of the first output result, the second output result, and the non-AI/ML model-based positioning result.

The first output result may indicate a position of a positioning target, and the second output result may indicate a time of arrival (ToA) between the positioning target and a specific transmission/reception point (TRP) and a confidence level of the ToA.

A circle may be assumed with a radius, which is a distance calculated based on an arrival time of the specific TRP having a highest confidence level among TRPs having confidence level greater than a confidence threshold, and a center, which is a position of the specific TRP, and the performance of the direct AI/ML positioning model may be determined to be normal when a shortest distance between the position of the positioning target according to the first output result and the circle is smaller than a performance threshold.

A circle may be assumed with a radius, which is a distance calculated based on an arrival time of the specific TRP having a highest confidence level among TRPs having confidence level greater than a confidence threshold, and a center, which is a position of the specific TRP, and the performance of the direct AI/ML positioning model may be determined to be abnormal when a shortest distance between the position of the positioning target according to the first output result and the circle is greater than a performance threshold.

The second output result may be a Line of Sight (LOS)/Non-Line of Sight (NLOS) soft indicator, and the non-AI/ML model-based positioning result may be a time of arrival (ToA) between the positioning target and the specific TRP.

The LOS/NLOS soft indicator may have a value ranging from 0 indicating NLOS to 1 indicating LOS, and may be an indicator indicating a possibility of an LOS propagation path.

A circle may be assumed with a radius, which is a distance calculated based on an arrival time of the specific TRP corresponding to a highest LOS/NLOS soft indicator, and a center, which is a position of the specific TRP, the performance of the direct AI/ML positioning model may be determined to be normal when a shortest distance between the position of the positioning target according to the first output result and the circle is smaller than a performance threshold, and the performance of the direct AI/ML positioning model may be determined to be abnormal when the shortest distance between the position of the positioning target according to the first output result and the circle is greater than the performance threshold.

The performance of the direct AI/ML positioning model may be adjusted through control of the performance threshold.

According to a third exemplary embodiment of the present disclosure, a communication device may comprise: at least one memory storing commands; at least one transceiver; and at least one processor connected to the at least one memory and the at least one transceiver, wherein the at least one processor may execute the commands to perform: receiving capability request information for artificial intelligence/machine learning (AI/ML)-based positioning from a network; and transmitting capability information based on the capability request information, wherein the capability information includes at least one of first information indicating whether the communication device supports AI/ML direct positioning, second information indicating whether the communication device supports AI/ML-assisted positioning, and third information indicating a type of a channel report related to the AI/ML-based positioning.

Each of the first information and the second information may be configured as boolean data, and the third information may indicate at least one of a channel impulse response (CIR), a delay profile (DP), a power delay profile (PDP), or a sample-based measurement related parameter.

The capability information may be transmitted to a location management function (LMF).

The present disclosure defines signals that have not yet been specified when applying AI/ML positioning technology in a mobile communication system and provides procedures for transmitting these signals. This enables utilization of the AI/ML positioning technology. Additionally, methods for monitoring the performance of a direct AI/ML positioning model are provided.

The effects that can be obtained through the specific exemplary embodiments of the present disclosure are not limited to those described above. For example, a person having ordinary skill in the related art may derive or understand various technical effects from the present disclosure. Accordingly, the specific effects of the present disclosure are not limited to those explicitly described herein but may include various effects that can be understood or inferred from the technical features of the present disclosure.

### BRIEF DESCRIPTION OF DRAWINGS

The following drawings have been prepared to describe a specific example of the present disclosure. The names of specific devices or specific signals/messages/fields indicated in the drawings are presented as examples, and thus, the technical features of the present disclosure are not limited to the specific names used in the following drawings.

FIG. 1 is a conceptual diagram illustrating a wireless communication system according to an exemplary embodiment of the present disclosure.

FIG. 2 is an exemplary diagram illustrating an NR system to which a data transmission method according to an exemplary embodiment of the present disclosure is applicable.

FIG. 3 is a diagram illustrating a resource grid supported by a radio access technology to which the present disclosure is applicable.

FIG. 4 is a diagram illustrating bandwidth parts supported by a radio access technology to which the present disclosure is applicable.

FIG. 5 is a diagram illustrating a synchronization signal block in a radio access technology to which the present disclosure is applicable.

FIG. 6 is a diagram illustrating an example of an AI/ML framework.

FIG. 7 is a conceptual diagram illustrating AI/ML-based positioning cases.

FIG. 8 is a sequence diagram illustrating capability transfer in LPP.

FIG. 9 is a sequence diagram illustrating capability indication in LPP.

FIG. 10 is a sequence diagram illustrating an assistance data request and response procedure in LPP.

FIG. 11 is a sequence diagram illustrating a measurement request and response procedure.

FIG. 12 is a sequence diagram illustrating an example of a gNB-LMF capability transfer procedure.

FIG. 13 is a sequence diagram illustrating a data collection configuration request procedure initiated by a gNB.

FIG. 14 is a sequence diagram illustrating a measurement request and response procedure.

FIG. 15 is a conceptual diagram illustrating a label-free performance monitoring method for a direct AI/ML positioning model.

FIG. 16 illustrates a communication system applicable to the present disclosure.

FIG. 17 illustrates a wireless device applicable to the present disclosure.

### DETAILED DESCRIPTION OF THE EMBODIMENTS

While the present disclosure is susceptible to various modifications and alternative forms, specific embodiments thereof are shown by way of example in the drawings. However, the present disclosure should not be construed as limited to the embodiments set forth herein, but on the contrary, the disclosure is to cover all modifications, equivalents, and alternatives falling within the spirit and scope of the embodiments. In describing each figure, like reference numerals are used for like elements.

While terms, such as “first”, “second”, “A”, “B,” etc. may be used to describe various components, such components must not be limited by the above terms. The above terms are used only to distinguish one component from another. For example, without departing from the scope of the present disclosure, a first component may be referred to as a second component, and similarly, a second component may also be referred to as a first component. Further, the term “and/or” includes combinations of a plurality of related listed items or any of a plurality of related listed items.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The terms used in the present description are merely used in order to describe particular embodiments, and are not intended to limit the scope of the present disclosure. An element described in the singular form is intended to include a plurality of elements unless the context clearly indicates otherwise. In the present description, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Unless otherwise defined, all terms including technical and scientific terms used in the present description have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, preferred embodiments according to the present disclosure will be described in detail with reference to the accompanying drawings.

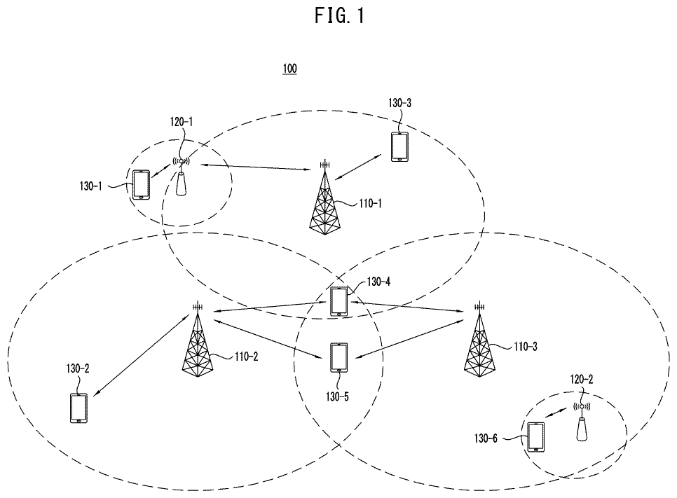

FIG. 1 is a conceptual diagram illustrating a wireless communication system according to an exemplary embodiment of the present disclosure.

Referring to FIG. 1, the wireless communication system 100 may include a plurality of communication nodes 110-1, 110-2, 110-3, 120-1, 120-2, 130-1, 130-2, 130-3, 130-4, 130-5, and 130-6.

Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple a (FDMA) based communication protocol, an orthogonal frequency division multiplexing (OFDM) based communication protocol, an orthogonal frequency division multiple access (OFDMA) based communication protocol, a single carrier (SC)-FDMA based communication protocol, a non-orthogonal multiplexing access (NOMA) based communication protocol, a space division multiple access (SDMA) based communication protocol, and the like.

The wireless communication system 100 may include a plurality of base stations 110-1, 110-2, 110-3, 120-1, and 120-2 and a plurality of UEs 130-1, 130-2, 130-3, 130-4, 130-5, and 130-6).

Each of the first base station 110-1, the second base station 110-2, and the third base station 110-3 may form a macro cell. Each of the fourth base station 120-1 and the fifth base station 120-2 may form a small cell. The fourth base station 120-1, the third UE 130-3, and the fourth UE 130-4 may belong to the coverage of the first base station 110-1. The second UE 130-2, the fourth UE 130-4, and the fifth UE 130-5 may belong to the coverage of the second base station 110-2. The fifth base station 120-2, the fourth UE 130-4, the fifth UE 130-5, and the sixth UE 130-6 may belong to the coverage of the third base station 110-3. The first UE 130-1 may belong to the coverage of the fourth base station 120-1. The sixth UE 130-6 may belong to the coverage of the fifth base station 120-2.

Here, each of the plurality of base stations 110-1, 110-2, 110-3, 120-1, and 120-2 may also be called a NodeB, an evolved NodeB, a next generation Node B (gNB), a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, and the like. Each of the plurality of UEs 130-1, 130-2, 130-3, 130-4, 130-5, and 130-6 may also be called a terminal, an access terminal, a mobile terminal, a station, a subscriber station, a mobile station, a portable subscriber station, a node, a device, and the like.

The plurality of communication nodes 110-1, 110-2, 110-3, 120-1, 120-2, 130-1, 130-2, 130-3, 130-4, 130-5, and 130-6 may support long term evolution (LTE), LTE-advanced (LTE-A), new radio (NR), and the like defined in cellular communication (e.g., 3rd generation partnership project (3GPP)) standards. The plurality of base stations 110-1, 110-2, 110-3, 120-1, and 120-2 may operate in different frequency bands or may operate in the same frequency band. The plurality of base stations 110-1, 110-2, 110-3, 120-1, and 120-2 may be connected to each other through an ideal backhaul or a non-ideal backhaul and may exchange information through an ideal backhaul or a non-ideal backhaul. Each of the plurality of base stations 110-1, 110-2, 110-3, 120-1, and 120-2 may be connected to a core network (not shown) through an ideal backhaul or a non-ideal backhaul. Each of the plurality of base stations 110-1, 110-2, 110-3, 120-1, and 120-2 may transmit a signal received from the core network to corresponding UEs 130-1, 130-2, 130-3, 130-4, 130-5, and 130-6 and transmit signals received from the corresponding UEs 130-1, 130-2, 130-3, 130-4, 130-5, and 130-6 to the core network.

Each of the plurality of base stations 110-1, 110-2, 110-3, 120-1, and 120-2 may support OFDMA-based downlink transmission and SC-FDMA-based uplink transmission. In addition, each of the plurality of base stations 110-1, 110-2, 110-3, 120-1, and 120-2 may support multiple input multiple output (MIMO) (e.g., single user (SU)-MIMO, multi-user (MU)-MIMO, massive MIMO, etc.), coordinated multipoint (COMP) transmission, carrier aggregation transmission, transmission in an unlicensed band, device-to-device (D2D) communication (or proximity services (ProSe)), and the like. Here, each of the plurality of UEs 130-1, 130-2, 130-3, 130-4, 130-5, and 130-6 may perform operations corresponding to the base stations 110-1, 110-2, 110-3, 120-1, and 120-2 and/or operations supported by the base stations 110-1, 110-2, 110-3, 120-1, and 120-2.

For example, the second base station 110-2 may transmit a signal to the fourth UE 130-4 based on SU-MIMO, and the fourth UE 130-4 may receive the signal from the second base station 110-2 according to SU-MIMO. The second base station 110-2 may transmit a signal to the fourth UE 130-4 and the fifth UE 130-5 based on MU-MIMO, and the fourth UE 130-4 and the fifth UE 130-5 may receive the signal from the second base station 110-2 according to MU-MIMO. Each of the first base station 110-1, the second base station 110-2, and the third base station 110-3 may transmit a signal to the fourth UE 130-4 based on COMP, and the fourth UE 130-4 may receive signals from the first base station 110-1, the second base station 110-2, and the third base station 110-3 according to COMP. Each of the plurality of base stations 110-1, 110-2, 110-3, 120-1, and 120-2 may transmit/receive a signal to/from the UEs 130-1, 130-2, 130-3, 130-4, 130-5, and 130-6 belonging to the coverage thereof based on CA.

Each of the first base station 110-1, the second base station 110-2, and the third base station 110-3 may coordinate D2D communication with the fourth UE 130-4 and the fifth UE 130-5, and each of the fourth UE 130-4 and the fifth UE 130-5 may perform D2D communication according to coordination of each of the second base station 110-2 and the third base station 110-3.

When a method (e.g., transmission or reception of a signal) performed by a first communication node among communication nodes is described, a second communication node corresponding thereto may perform a method (e.g., reception or transmission of a signal) corresponding to the method performed by the first communication node. That is, when the operation of a UE is described, the corresponding base station may perform the operation corresponding to the operation of the UE. On the other hand, when the operation of a base station is described, the corresponding UE may perform the operation corresponding to the operation of the base station.

Hereinafter, downlink (DL) means communication from a base station to a UE, and uplink (UL: uplink) means communication from a UE to a base station. In downlink, a transmitter may be a part of a base station and a receiver may be a part of a UE. In uplink, a transmitter may be a part of a UE and a receiver may be a part of a base station.

With the recent rapid spread of smartphones and Internet of Things (IoT) UEs, the amount of information exchanged through a communication network is increasing. Accordingly, it is necessary to consider an environment (e.g., enhanced mobile broadband communication) that provides faster services to more users than the existing communication system (or the existing radio access technology) in next-generation wireless access technology. To this end, design of a communication system in consideration of machine type communication (MTC) providing services by connecting a plurality of devices and objects is under discussion. In addition, design of a communication system (e.g., ultra-reliable and low latency communication (URLLC)) considering services and/or UEs sensitive to communication reliability and/or latency is under discussion.

Hereinafter, for convenience of description, the next-generation radio access technology is referred to as new radio access technology (RAT), and a wireless communication system to which the new RAT is applied is referred to as a new radio (NR) system in the present description. In the present description, frequencies, frames, subframes, resources, resource blocks, regions, bands, subbands, control channels, data channels, synchronization signals, various reference signals, various signals or various messages related to NR may be interpreted in various meanings used in the past and present or will be used in the future.

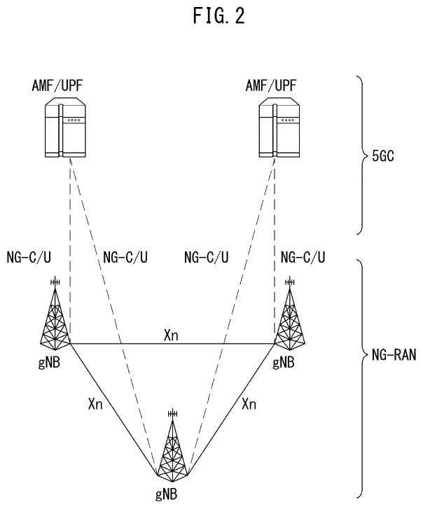

FIG. 2 is an exemplary diagram illustrating an NR system to which a data transmission method according to an exemplary embodiment of the present disclosure is applicable.

NR, which has been standardized in 3GPP, provides an improved data rate compared to LTE and can satisfy various QoS requirements for each segmented and detailed usage scenario. In particular, enhancement mobile broadband (eMBB), massive MTC (mMTC), and ultra-reliable and low latency communications (URLLC) have been defined as representative usage scenarios of NR. As a method for satisfying requirements for each scenario, a frame structure that is flexible compared to LTE is provided. The frame structure of NR supports a frame structure based on multiple subcarriers. A basic subcarrier spacing (SCS) is 15 kHz, and a total of 5 types of SCS are supported at 15 kHz*2ⁿ.

Referring to FIG. 2, a next generation-radio access network (NG-RAN) includes gNBs that provide an NG-RAN user plane (SDAP/PDCP/RLC/MAC/PHY) and control plane (RRC) protocol termination for UEs. Here, NG-C represents a control plane interface used for an NG2 reference point between NG-RAN and 5-generation core (5GC). NG-U represents a user plane interface used for an NG3 reference point between NG-RAN and 5GC.

The gNBs are interconnected through the Xn interface and connected to the 5GC through an NG interface. More specifically, a gNB is connected to an access and mobility management function (AMF) through the NG-C interface and connected to a user plane function (UPF) through the NG-U interface.

In the NR system of FIG. 2, multiple numerologies may be supported. Here, numerology may be defined by a subcarrier spacing and a cyclic prefix (CP) overhead. In this case, a plurality of subcarrier spacings may be derived by scaling the basic subcarrier spacing with an integer. Further, even though it is assumed that a very low subcarrier spacing is not used at a very high carrier frequency, a numerology to be used can be selected independently of the frequency band.

In addition, in the NR system, various frame structures according to a number of numerologies may be supported.

Hereinafter, a NR waveform, numerologies, and frame structures will be described.

In NR, a CP-OFDM waveform using a cyclic prefix is used for downlink transmission, and CP-OFDM or DFT-s-OFDM is used for uplink transmission. OFDM technology is easy to combine with MIMO (Multiple Input Multiple Output) and has advantages of using a low-complexity receiver with high frequency efficiency.

In NR, since requirements for a data rate, a delay rate, coverage, and the like are different for each of the three scenarios described above, it is necessary to efficiently satisfy the requirements for each scenario through a frequency band constituting an arbitrary NR system. To this end, technology for efficiently multiplexing radio resources based on a plurality of different numerologies has been proposed.

Specifically, NR transmission numerology is determined based on a sub-carrier spacing and a cyclic prefix (CP) and changed using a value u as an exponential value of 2 based on 15 kHz as shown in Table 1 below.

TABLE 1

| | | | Supported | Supported |
|---|---|---|---|---|
| μ | SCS (kHz) | Cyclic prefix | for data | for synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

As shown in Table 1, NR numerologies may be divided into five types according to the subcarrier spacing. This is different from the fact that the subcarrier spacing of LTE, one of the 4G communication technologies, is fixed to 15 kHz. Specifically, subcarrier spacings used for data transmission are 15, 30, 60, and 120 kHz, and subcarrier spacings used for synchronization signal transmission are 15, 30, 120 and 240 kHz in NR. In addition, an extended CP is applied only to the 60 kHz subcarrier spacing. On the other hand, in the frame structure in NR, a frame composed of 10 subframes each having a length of 1 ms and having a length of 10 ms is defined. One frame can be divided into half frames of 5 ms, and each half frame includes 5 subframes. In the case of a 15 kHz subcarrier spacing, one subframe is composed of one slot, and each slot includes 14 OFDM symbols.

Hereinafter, NR physical resources will be described.

With respect to physical resources in NR, an antenna port, a resource grid, a resource element, a resource block, a bandwidth part, etc. are considered.

An antenna port is defined such that a channel on which a symbol on an antenna port is carried can be inferred from a channel on which another symbol on the same antenna port is carried. When the large-scale property of a channel carrying a symbol on one antenna port can be inferred from a channel carrying a symbol on another antenna port, the two antenna ports may be regarded as being in a QC/QCL (quasi co-located or quasi co-location) relationship. Here, the large-scale property includes one or more of delay spread, Doppler spread, frequency shift, average received power, and received timing.

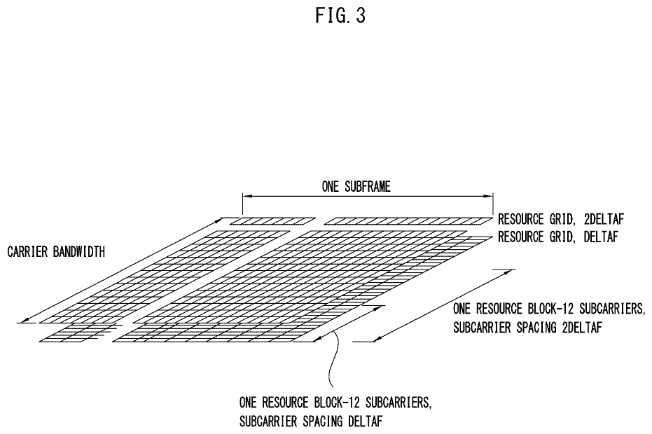

FIG. 3 is a diagram illustrating a resource grid supported by a radio access technology to which the present disclosure is applicable.

Referring to FIG. 3, since NR supports a plurality of numerologies on the same carrier, a resource grid may be present according to each numerology. In addition, the resource grid may be present according to an antenna port, a subcarrier spacing, and a transmission direction.

A resource block is composed of 12 subcarriers and is defined only in the frequency domain. In addition, a resource element is composed of one OFDM symbol and one subcarrier. Accordingly, the size of one resource block may vary according to the subcarrier spacing, as shown in FIG. 3. In addition, “Point A” serving as a common reference point for a resource block grid, a common resource block, a virtual resource block, and the like are defined in NR.

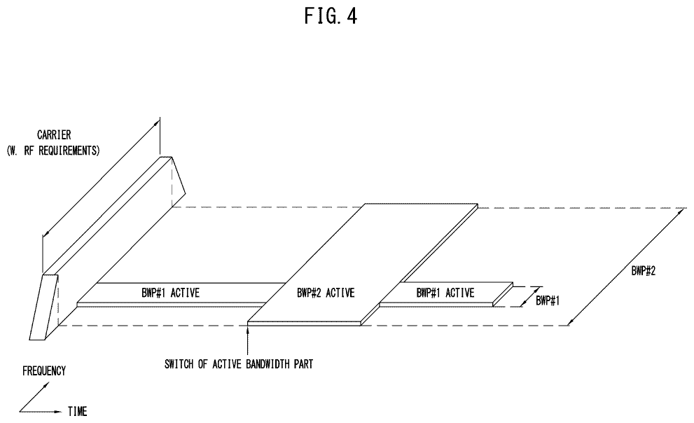

FIG. 4 is a diagram illustrating bandwidth parts supported by a radio access technology to which the present disclosure is applicable.

Unlike LTE in which the carrier bandwidth is fixed to 20 MHz, the maximum carrier bandwidth is set to 50 MHz to 400 MHz for each subcarrier spacing in NR. Therefore, it is not assumed that all UEs use all of these carrier bandwidths. Accordingly, as shown in FIG. 4, a bandwidth part (BWP) may be designated within a carrier bandwidth and used by a UE in NR. In addition, a bandwidth part is associated with one numerology and composed of a subset of consecutive common resource blocks, and may be dynamically activated with time. A maximum of four bandwidth parts is configured for a UE in uplink and downlink, and data is transmitted/received using an activated bandwidth part at a given time.

Uplink and downlink bandwidth parts are independently set in the case of a paired spectrum, whereas downlink and uplink bandwidth parts are set in pairs to share a center frequency in order to prevent unnecessary frequency re-tuning between downlink and uplink operations in the case of an unpaired spectrum.

Hereinafter, NR initial access will be described.

In NR, a UE performs cell search and random access procedures in order to access a base station and perform communication.

Cell search is a procedure in which a UE synchronizes with a cell of a corresponding base station using a synchronization signal block (SSB) transmitted by the base station, obtains a physical layer cell ID, and obtains system information.

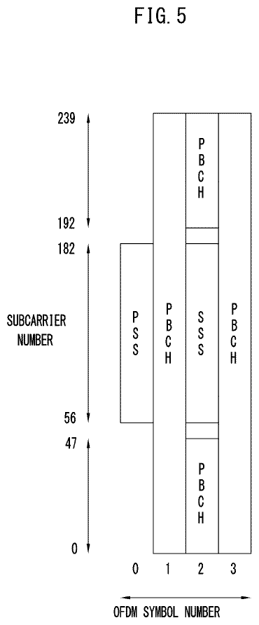

FIG. 5 is a diagram illustrating a synchronization signal block in a radio access technology to which the present disclosure is applicable.

Referring to FIG. 5, the SSB is composed of a primary synchronization signal (PSS) and a secondary synchronization signal (SSS) each occupying one symbol and 127 subcarriers, and a PBCH spanning 3 OFDM symbols and 240 subcarriers.

A UE receives the SSB by monitoring the SSB in the time and frequency domains.

The SSB can be transmitted up to 64 times in 5 ms. A plurality of SSBs is transmitted using different transmission beams within 5 ms, and the UE performs detection on the assumption that SSBs are transmitted every 20 ms when viewed based on one specific beam used for transmission. The number of beams that can be used for SSB transmission within 5 ms may increase as the frequency band increases. For example, a maximum of 4 SSB beams can be transmitted at 3 GHz or less, and SSBs can be transmitted using a maximum of 8 different beams in a frequency band of 3 to 6 GHz and using a maximum of 64 different beams in a frequency band of 6 GHz or more.

Two SSBs are included in one slot, and the start symbol and the number of repetitions in the slot are determined according to a subcarrier spacing.

The SSB is not transmitted at the center frequency of a carrier bandwidth, unlike the SS in the conventional LTE. That is, the SSB may be transmitted in a place other than the center of the system band, and a plurality of SSBs may be transmitted in the frequency domain when broadband operation is supported. Accordingly, the UE monitors the SSB using a synchronization raster that is a candidate frequency position for monitoring the SSB. A carrier raster and a synchronization raster, which are center frequency position information of a channel for initial access, are newly defined in NR, and the synchronization raster has a wider frequency interval than the carrier raster and thus can support rapid SSB search of the UE.

The UE may acquire a master information block (MIB) through a PBCH of the SSB. The MIB includes minimum information for the UE to receive remaining minimum system information (RMSI) broadcast by a network. In addition, the PBCH may include information on the position of the first DM-RS symbol in the time domain, information for the UE to monitor SIB1 (e.g., SIB1 numerology information, information related to SIB1 CORESET, search space information, PDCCH related parameter information, etc.), offset information between a common resource block and the SSB (the position of the absolute SSB in a carrier is transmitted through SIB1), and the like. Here, the SIB1 numerology information is equally applied to some messages used in the random access procedure for the UE to access the base station after the UE completes the cell search procedure. For example, the SIB1 numerology information may be applied to at least one of messages 1 to 4 for the random access procedure.

The aforementioned RMSI may mean system information block 1 (SIB1), and SIB1 is periodically broadcast (e.g., 160 ms) in the cell. SIB1 includes information necessary for the UE to perform an initial random access procedure and is periodically transmitted through a PDSCH. To receive SIB1, the UE needs to receive numerology information used for SIB1 transmission and control resource set (CORESET) information used for SIB1 scheduling SIB1 through a PBCH. The UE checks scheduling information for SIB1 using an SI-RNTI in CORESET and acquires SIB1 on the PDSCH according to the scheduling information. SIBs other than SIB1 may be transmitted periodically or may be transmitted according to the request of the UE.

Hereinafter, an AI/ML framework will be described.

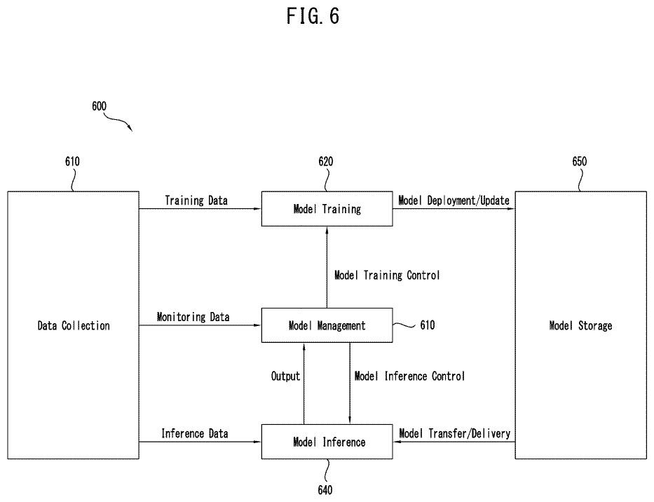

FIG. 6 is a diagram illustrating an example of an AI/ML framework.

Referring to FIG. 6, an AI/ML framework 600 may include a data collection block 610, a model training block 620, a model management block 630, a model inference block 640, and a model storage block 650. FIG. 6 merely presents an example of an AI/ML framework, and various entities, functions, or blocks not illustrated in FIG. 6 may be added to the AI/ML framework, while at least some of the blocks illustrated in FIG. 6 may be omitted.

The data collection block 610 may be involved in a lifecycle management (LCM) process for various purposes, such as model training, model inference, model monitoring, model selection, and model updates. The data collection block 610 in FIG. 6 conceptually represents data sources and entities that hold data for training, inference, and monitoring. Although the data collection block 610 in FIG. 6 is represented as a single block, data collection for training, inference, and monitoring may have different characteristics and requirements. Additionally, timescales for training and monitoring (e.g. real-time or offline) may require separate considerations.

Regarding training, training data may initially be generated in a network and a UE. The initial data may be collected (or transmitted) to one or more data collection entities. The data collection entity may be owned by various entities, such as internal or external UE/chipset/network vendor, network operator, and positioning service provider.

Regarding inference, inference data for a UE-sided model and/or a UE part of a two-sided model may be transmitted or provided directly by the UE. Inference data for a network-sided model and/or a network part of a two-sided model may be transmitted or provided directly by the network or may be transmitted from the UE.

Regarding monitoring, monitoring data for UE-side monitoring may be transmitted or provided directly by the UE. Monitoring data for network-side monitoring may be transmitted or provided directly by the network or may be transmitted from the UE.

Data collection for real-time operations such as real-time model monitoring, switching, and selection may cause significant signaling overhead. Conversely, infrequent data collection to reduce signaling overhead may introduce latency in real-time model monitoring, switching, and selection.

The model training block 620 may perform both initial training and model updates. In general, model training may be classified into model training conducted during development of a model and subsequent training for the developed model. The model training block 620 in FIG. 6 is illustrated as a single block for simplicity.

Depending on a location of a dataset and/or a location of a model (or an untrained model), training may be performed by an internal network entity or by an external entity such as a UE/chipset/network vendor, network operator, or positioning service provider. Since AI/ML model development is generally an iterative process involving data collection, model design, training, and performance validation, careful implementation considerations are required regarding power consumption, hardware constraints, latency, and concurrency with other layer functions in AI/ML model development.

When large-scale field data is collected by the data collection entity, a supplier responsible for model development may need to be able to use the data. In general, model development is an offline engineering process conducted by an engineering team, requiring access to large-scale datasets collected from the field. That is, decisions on model structure, device-specific optimizations, and the number of models to be developed (e.g. generalized models versus specific models) may vary depending on the large-scale field data. If the supplier owning the data collection entity is different from the supplier responsible for model development, the model development supplier may need to be able to access the datasets. This may be achieved through explicit dataset sharing or by providing access to the collected datasets. The dataset sharing/access may be related to a two-sided model in which both a gNB supplier and a UE/chipset supplier participate in the model development and training process.

After a model is developed and trained, the model may be stored in a model repository or the model storage block 650 and delivered to a target device. The model may be compiled into an executable file for inference. Various methods may exist depending on where the model is trained, a format in which the model is stored or delivered, and where the model is hosted before delivery.

The model inference block 640 may provide AI/ML model inference outputs, such as predictions or decisions. The model inference block 640 may also provide model performance feedbacks to the model training block 620. The model inference block 640 may be responsible for data preparation, such as data preprocessing, cleaning, formatting, and transformation, based on inference data provided by the data collection block 610.

The model management block may perform functionality/model monitoring, selection, activation, deactivation, switching, fallback, and the like. FIG. 6 illustrates a single model management block 630, but not all aspects of model management may be implemented at a single location. Some aspects of model monitoring, activation/deactivation, selection, switching, and fallback may be performed on the network side, while other aspects may be performed on the UE side. Regarding model selection, activation, deactivation, switching, and fallback for a UE-sided model and two-sided model, the following mechanisms may be considered: a mechanism related to a network-initiated decision made by the network, a mechanism related to a UE-initiated decision requested by the UE and made by the network, a mechanism related to a decision triggered by a network-configured event, made by the UE, and reported to the network, a mechanism related to a UE-autonomous decision reported to the network, and a mechanism related to a UE-autonomous decision, which is not reported to the network.

For convenience of description, the present disclosure primarily describes AI-based positioning from the perspective of artificial neural networks. However, proposed methods described below may be extended to artificial neural networks applied for other purposes in a wireless mobile communication system. In the following description, network configuration is used as a term encompassing base station configuration and/or terminal configuration.

Positioning technology in a mobile communication system plays a critical role in determining a precise position of a specific terminal. Mobile communication-based positioning schemes may be classified into UE-based positioning and network-based positioning, depending on which entity is responsible for position calculation. The network-based positioning is preferred due to its advantages in facilitating data integration and supporting existing terminals. Additionally, the mobile communication-based positioning schemes may be classified into four categories based on a type of data used: (1) cell-ID-based, (2) angle-based, (3) range-based, and (4) fingerprint-based.

Recently, a need to improve positioning accuracy in indoor environments, where non-line-of-sight (NLOS) conditions are common, has increased significantly for various use cases such as indoor navigation, logistics, and warehouse management. Accordingly, discussions on positioning accuracy improvements using AI/ML technology have been actively conducted.

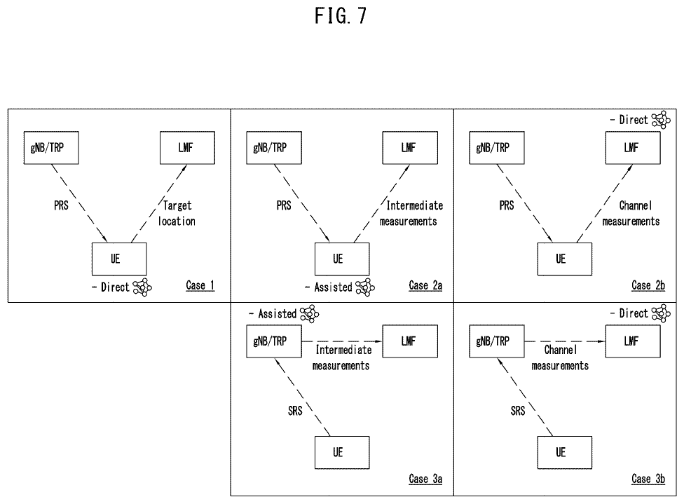

FIG. 7 is a conceptual diagram illustrating AI/ML-based positioning cases.

Referring to FIG. 7, AI/ML-based positioning schemes may be broadly classified into two types. The first type may be direct AI/ML positioning, where an inference result of an AI/ML model directly represents a UE's position. The second type may be AI/ML-assisted positioning, where an inference result of an AI/ML model is used to assist existing positioning algorithms. The UE or location management function (LMF) may make the final determination (estimation) of the UE's position, and depending on the entity responsible for determining the UE's position, the positioning scheme may be classified as UE-based or LMF-based. The present disclosure categorizes AI/ML-based positioning into five cases, as shown in FIG. 7.

Case 1 corresponds to a UE-based positioning scheme, while Cases 2a/2b and 3a/3b correspond to LMF-based positioning schemes. Cases 1, 2a, and 2b utilize downlink positioning reference signal (PRS), whereas Cases 3a and 3b utilize uplink sounding reference signal (SRS). Case 2a and Case 3a correspond to AI/ML-assisted positioning schemes, while Case 2b and Case 3b correspond to direct AI/ML positioning scheme. These schemes may also be distinguished based on a location of the AI/ML model.

The main exemplary embodiments of the present disclosure are based on Cases 1, 3a, and 3b, but exemplary embodiments based on Cases 2a and 2b are also disclosed. The present disclosure provides data collection, inference, and monitoring procedures required when applying artificial neural network-based positioning technology in a mobile communication system based on the five cases described above. Additionally, the present disclosure provides methods for defining new signals and signal transmission procedures used in these data collection, inference, and monitoring procedures. Furthermore, when direct AI/ML positioning schemes are used, methods for monitoring the performance of the AI/ML positioning model is provided.

Referring to FIG. 7, Case 1 may correspond to a UE-based direct AI/ML positioning case in which an AI/ML model is located in the UE. Regarding Case 1, channel impulse response (CIR), power delay profile (PDP), and/or delay profile (DP), measured using DL PRS may be used as input to an AI/ML positioning model. Here, a direct AI/ML positioning model that outputs the UE's position may be used. Label generation for model training may be performed by a positioning reference unit (PRU). The PRU is a device that accurately knows its own position and may be able to perform all UE functions related to positioning, such as performing measurements after receiving DL PRS and transmitting UL SRS. If PRU(s) cannot be utilized to obtain labels, results (e.g. UE position information) of conventional positioning technology using GNSS, BLE, WiFi, etc., may be used.

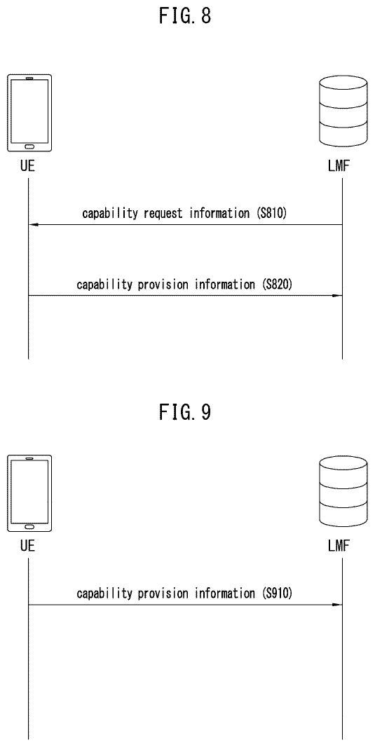

FIG. 8 is a sequence diagram illustrating capability transfer in LPP, and FIG. 9 is a sequence diagram illustrating capability indication in LPP.

The LMF may need to determine whether an AI/ML positioning functionality is included (or supported) among various positioning-related functionalities or capabilities of the UE. The existing UE positioning functionalities, such as ECID, multi-RTT, and DL-TDOA, may be informed from the UE to the LMF through a capability transfer process of an LTE positioning protocol (LPP). The AI/ML positioning functionality of the UE may also be informed from the UE to the LMF through the capability transfer process or capability indication process of LPP.

Hereinafter, functionality identification is proposed with reference to FIGS. 8 and 9. Referring to FIGS. 8 and 9, the capability transfer process or the capability indication process of LPP may be used to inform the LMF of the UE's AI/ML positioning functionality.

The capability transfer process of LPP according to FIG. 8 includes step S810, in which the LMF transmits capability request information (i.e. RequestCapabilities IE) to the UE, and step S820, in which the UE transmits capability provision information (i.e. ProvideCapabilities IE) to the LMF. According to the present exemplary embodiment, to enable the UE to inform the LMF of the UE's AI/ML positioning functionality, new field(s) and IE(s) may be defined in each message, as exemplified below.

For example, Tables 2 and 3 illustrate an aiml-RequestCapabilities field and an AIML-RequestCapabilities IE, which are configured to be included in the capability request information (i.e. RequestCapabilities IE) in step S810.

```
TABLE 2
-- ASN1START
RequestCapabilities-r9-IEs ::= SEQUENCE {
    ...
  aiml-RequestCapabilities AIML-RequestCapabilities OPTIONAL,
  ...
}
-- ASN1STOP
```

TABLE 3

```
-- ASN1START
AIML-RequestCapabilities ::= SEQUENCE {
    aiml-PositioningReq BOOLEAN,
  aiml-ChannelReportTypeReq LIST,
    ...
}
-- ASN1STOP
```

Here, aiml-PositioningReq may request whether AI/ML positioning capability is available to distinguish the UE from a legacy UE, and aiml-ChannelReportTypeReq may refer to list-type data (e.g. sample-based CIR/PDP/DP and sample-based measurement-related parameters, and path-based path magnitude and delay) for a list of channel response report types that the UE can provide. As another example, Tables 4 to 5 illustrate an nr-aiml-ProvideCapabilities field included in the capability provision information (i.e. ProvideCapabilities IE) in step S820 and its subordinate NR-AIML-ProvideCapabilities IE.

```
TABLE 4
-- ASN1START
ProvideCapabilities-r9-IEs ::= SEQUENCE {
    ...
  nr-aiml-ProvideCapabilities NR-AIML-ProvideCapabilities OPTIONAL,
  ...
}
-- ASN1STOP
```

TABLE 5

```
-- ASN1START
NR-AIML-ProvideCapabilities :: = SEQUENCE {
  aiml-direct BOOLEAN,
    aiml-assisted BOOLEAN
    aiml-channelReportTypeList LIST,
    ...
}
-- ASN1STOP
```

Here, aiml-direct may refer to boolean data that instructs the UE to perform direct AI/ML positioning, aiml-assisted may refer to boolean data that instructs the UE to perform AI/ML-assisted positioning, and aiml-channelReportTypeList may refer to list-type data (e.g. sample-based CIR/PDP/DP and sample-based measurement-related parameters, and path-based path magnitude and delay) for a list of AI/ML-based channel report types provided to the UE. The capability indication process of LPP according to FIG. 9 may include step S910, in which the UE transmits capability provision information (i.e. ProvideCapabilities IE) to the LMF to indicate the UE's capabilities. Here, step S910 may be the same as step S820 in FIG. 8. That is, the ProvideCapabilities IE in step S910 may have the same information field structure as in Table 4 or Table 5.

According to the present exemplary embodiment, the names of the information element fields disclosed in Tables 2 to 5 are merely examples, and even if they are replaced with other names having the same functions and meanings, they may still correspond to the present exemplary embodiment in a substantially identical manner.

In Case 1, the LCM process, including activation, deactivation, monitoring, switching, and fallback of models, may be performed on the UE-side (UE or OTT server). For example, a UE manufacturer may generate an AI/ML positioning model by collecting data and training the model and then deploy the model to the UE. Alternatively, due to the UE's limited available power, training of the AI/ML model may be performed on the UE-side OTT server. The data collected for model training (or training data) may be classified into a part A and part B. Here, the part A may include at least one of measured data (e.g. channel measurement data), quality indicators of channel measurements, and timestamps of channel measurements, while the part B may include at least one of labels, quality indicators of labels, and timestamps of labels.

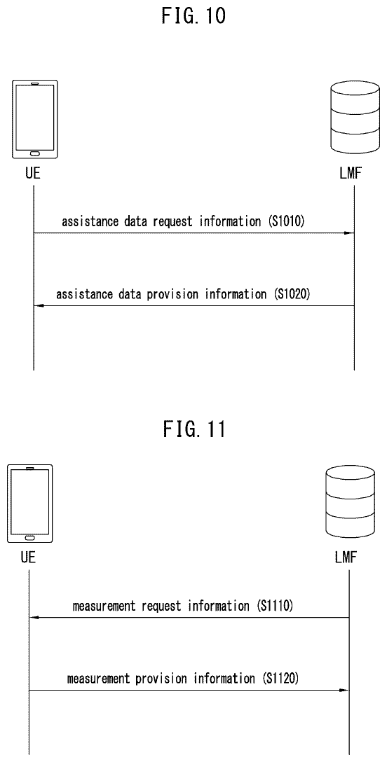

FIG. 10 is a sequence diagram illustrating an assistance data request and response procedure in LPP.

FIG. 10 illustrates step S1010, in which the UE transmits assistance data request information (i.e. RequestAssistance Data IE) to the LMF, and step S1020, in which the LMF transmits assistance data provision information (i.e. ProvideAssistanceData IE) to the UE.

Referring to FIG. 10, in order to perform data collection for training, inference, or monitoring of a positioning model, the terminal may perform a procedure or operation of requesting the LMF to configure a DL PRS positioning environment. For example, the procedure of requesting DL PRS positioning environment configuration may be a UE-initiated procedure, in which the terminal requests the LMF for a preferred DL PRS configuration for collecting data for training, inference, or monitoring. As another example, the procedure of configuring the DL PRS positioning environment may be an LMF-initiated procedure, in which the LMF determines a DL PRS configuration for collecting data for training, inference, or monitoring and then transmits the configuration to the terminal through assistance information.

Here, the aforementioned DL PRS configuration may be for the part A of the training data and may be transmitted through assistance information related to the training data.

Meanwhile, in order for the UE to perform conventional positioning, the UE may transmit a RequestAssistData message of LPP to the LMF to request configuration of the positioning environment, such as DL PRS.

The RequestAssistanceData message may exists separately for each conventional positioning scheme, such as NR-DL-TDOA-RequestAssistance Data, NR-DL-AoD-RequestAssistance Data, and NR-Multi-RTT-RequestAssistanceData. Specifically, the UE may request DL PRS positioning environment configuration by using an NR-On-Demand-DL-PRS-Request IE in the RequestAssistance Data message.

When requesting the configuration of the DL PRS transmission environment for data collection used in the training or inference of the AI/ML positioning model, a newly defined RequestAssistanceData message in LPP may be used. The performance monitoring of the AI/ML positioning model in Case 1 may be performed at the discretion of the UE manufacturer or other relevant entities.

Referring to FIG. 7, Case 2a may represent UE-assisted/LMF-based positioning with a UE-sided model and AI/ML-assisted positioning. In relation to Case 2a, an AI/ML positioning model may be located in the UE, and CIR/PDP/DP measured using DL PRS may be used as input to the AI/ML positioning model. Here, an AI/ML-assisted positioning model that outputs intermediate measurements, such as timing information and LOS/NLOS indicators, may be used. The training of the model and data collection may be performed on the UE-side (UE or OTT server).

To perform positioning, the terminal may request the LMF to configure a DL PRS positioning environment. For example, the configuration of the DL PRS positioning environment may be a UE-initiated procedure, in which the terminal requests the LMF for a preferred DL PRS configuration to collect data for training, inference, or monitoring. As another example, the configuration of the DL PRS positioning environment may be an LMF-initiated procedure, in which the LMF determines a DL PRS configuration for collecting data for training, inference, or monitoring and then transmits the configuration to the terminal through assistance information.

Here, the aforementioned DL PRS configuration may be for the part A of the training data and may be transmitted through assistance information related to the training data.

As in Case 1, when requesting the configuration of the DL PRS transmission environment for data collection used in the training, inference, or monitoring of the AI/ML positioning model, a newly defined RequestAssistanceData message in LPP may be used.

Hereinafter, methods of configuring the DL PRS environment for data collection will be described.

When an AI/ML positioning model is implemented within the UE (e.g. in Case 1 and Case 2a), that is, when the AI/ML positioning model is a UE-sided model, an approach is proposed to redefine and utilize the RequestAssistance Data message in the existing LPP so that the UE can transmit a request to the LMF to configure the data collection environment for training, inference, or monitoring of the AI/ML positioning model. For example, an NR-AIML-RequestAssistanceData message (this name is arbitrarily defined) may be defined, and the message may include information necessary for configuring the DL PRS transmission environment for AI/ML positioning model training, inference, or monitoring (e.g. DL PRS transmission frequency, bandwidth usage, sampling rate, and PRS signal power level).

Assistance/support from the LMF, which has position information of PRU(s), may be required for generating labels. The LMF may calculate labels corresponding to intermediate measurements such as timing information in reverse by using position information of TRP(s) and PRU(s). The entity responsible for training the AI/ML model may receive label information from the LMF, which has the position information of PRU(s), and new signaling may be defined for this purpose.

For example, as in the aforementioned functionality identification method, information on whether the UE possesses AI/ML-assisted positioning functionality may be transmitted to the LMF through the existing UE capability transfer process in LPP. A method for requesting the configuration of an environment such as DL PRS for data collection from the LMF may involve defining a new RequestAssistance Data message (e.g. NR-AIML-RequestAssistanceData) in LPP, as in the aforementioned DL PRS environment configuration method for data collection, and utilizing it to request the configuration of an environment for AI/ML positioning model training, inference, or monitoring.

Case 2b illustrates UE-assisted/LMF-based positioning with an LMF-sided model and direct AI/ML positioning.

In relation to Case 2b, an AI/ML positioning model is located in the LMF, and a direct AI/ML positioning model that takes CIR/PDP/DP measured using DL PRS as input and outputs position information of the UE may be used.

The UE may calculate channel responses such as CIR/PDP/DP using DL PRS and transmit the calculated channel responses to the LMF. To this end, the UE may need to inform the LMF that the UE has the capability to calculate and report the channel responses. For this purpose, the aforementioned functionality identification method may be used.

FIG. 11 is a sequence diagram illustrating a measurement request and response procedure.

FIG. 11 includes step S1110, in which the UE transmits measurement request information (i.e. RequestMeasurement IE) to the LMF, and step S1120, in which the LMF transmits measurement provision information or measurement information (i.e. ProvideMeasurements IE) to the UE. For training or inference of the AI/ML positioning model, the LMF may request the UE to measure and report the channel responses, and in response, the UE may report the measured channel responses to the LMF. The request and/or reporting-related messages may be newly defined in LPP. For example, as shown in FIG. 11, a RequestMeasurements message from the LMF to the UE and a corresponding ProvideMeasurements message as a UE response may be defined. Additionally, to transmit the sample-based channel responses measured by the UE to the LMF, a new IE in the ProvideMeasurements message may be defined (e.g. UE Channel Measurement IE, where this IE name is arbitrarily defined).

Meanwhile, the examples in FIGS. 8 to 11 may be applied to sidelink positioning.

Specifically, the UE and LMF in FIGS. 8 to 11 may correspond to endpoints of sidelink positioning. Here, the endpoints of sidelink positioning may include at least one of a sidelink server UE, an LMF, and a location server. That is, FIG. 8 corresponds to a sequence diagram of capability transfer between a first endpoint and a second endpoint, FIG. 9 corresponds to a sequence diagram of capability indication between a first endpoint and a second endpoint, FIG. 10 corresponds to a sequence diagram of assistance data request and response between a first endpoint and a second endpoint, and FIG. 11 corresponds to a sequence diagram of measurement request and response between a first endpoint and a second endpoint.

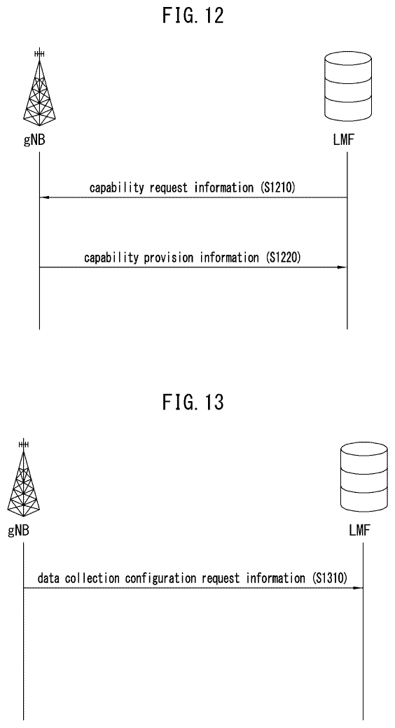

FIG. 12 is a sequence diagram illustrating an example of a gNB-LMF capability transfer procedure.

Here, the example of FIG. 12 may be applied to sidelink positioning. Specifically, the example of FIG. 12 corresponds to a capability transfer procedure between a first endpoint and a second endpoint. Additionally, in FIG. 12, an gNB is an example of a base station, and the procedure in FIG. 12 may be extended to apply to a base station other than a gNB.

FIG. 12 includes step S1210, in which the LMF transmits capability request information or capability information request (i.e. RequestCapabilities IE) to the base station, and step S1220, in which the base station transmits capability provision information or capability information (i.e. ProvideCapabilities IE) to the LMF. Here, the capability information transmitted in step S1220 may be the same as the capability provision information in FIG. 8 and/or FIG. 9. Alternatively, the capability information transmitted in step S1220 may be different from the capability provision information in FIG. 8 and/or FIG. 9. The following describes a proposed method for transmitting sample-based channel responses with reference to FIG. 12.

To transmit the sample-based channel responses measured by the UE to the LMF, a new ‘UE Channel Measurement Information Element (IE)’ may be defined in the ProvideMeasurements message, and a method utilizing this new IE is proposed.

For example, the UE Channel Measurement IE (this name is arbitrarily defined) may be defined as follows: T32Q8 refers to an 8-bit quantized magnitude value for each of 32 channel taps. The aforementioned example is merely an example, and other combinations of channel taps and quantization bits may be possible. The tap indication may be expressed as a bitmap indicating taps corresponding to transmitted magnitudes among a total of 256 channel taps. When transmitting the magnitudes for all 256 taps, the transmission of the tap indication field may be omitted.

Table 6 illustrates an example of the UE Channel Measurement IE.

TABLE 6

| IE/Group Name [symbol] | Presence [symbol] | Range [symbol] | Note [symbol] |
|---|---|---|---|
| gNB Channel | M [symbol] | [symbol] | [symbol] |
| Measurement [symbol] | | | |
| > CHOICE Channel | M [symbol] | [symbol] | [symbol] |
| Magnitude [symbol] | | | |
| >> T3208 [symbol] | [symbol] | 32 × 8 bits [symbol] | [symbol] |
| >> T32Q16 [symbol] | [symbol] | 32 × 16 bits [symbol] | [symbol] |
| >> T64Q8 [symbol] | [symbol] | [symbol] | [symbol] |
| >> T64Q16 [symbol] | [symbol] | [symbol] | [symbol] |
| >> T128Q8 [symbol] | [symbol] | [symbol] | [symbol] |
| >> T128Q16 [symbol] | [symbol] | [symbol] | [symbol] |
| >> T256Q8 [symbol] | [symbol] | [symbol] | [symbol] |
| >> T256Q16 [symbol] | [symbol] | 256 × 16 bits [symbol] | [symbol] |
| > Tap indication [symbol] | O [symbol] | 256 bits [symbol] | Exists except |
| | | | for T256Q8 |
| | | | and T256Q16 [symbol] |

Case 3a represents NG-RAN node-assisted positioning with a gNB-sided model and AI/ML-assisted positioning.

Regarding Case 3a, an AI/ML positioning model may be located in the gNB, and an AI/ML-assisted positioning method may be considered, where the AI/ML positioning model uses CIR/PDP/DP measured by the gNB using UL SRS as input and outputs intermediate measurements such as timing information and LOS/NLOS indicators. The gNB may transmit the intermediate measurements to the LMF, and based on the intermediate measurements, the LMF may calculate a UE's position using a conventional positioning method. Data collection for model training may be performed at the gNB or OAM. The LMF may provide guidance or information for data collection, such as uplink SRS configuration.

The AI/ML positioning model located in the gNB may be either a model independently operated by the gNB manufacturer or a model managed by the LMF. In the case of a model independently operated by the gNB manufacturer, the LMF may need to be aware of whether the gNB possesses the AI/ML-assisted positioning model. To this end, a capability transfer procedure between the gNB and the LMF may be newly defined in an NR positioning protocol A (NRPPa).

Hereinafter, a gNB capability transfer process is proposed.

Specifically, a procedure is proposed in which the LMF transmits a RequestCapabilities message to the gNB, and the gNB responds with a ProvideCapabilities message, allowing the LMF to verify whether the gNB possesses the AI/ML-based assisted positioning model.

In the case of an AI/ML model independently operated by the gNB manufacturer, an environment for collecting inference data for the AI/ML positioning model, such as UL SRS, is defined in the existing LPP and NRPPa. However, the gNB may initiate configuration of an environment for collecting training data for the AI/ML positioning model, and the corresponding message may not exist in the existing NRPPa and may be newly defined. Here, AI/ML positioning model training data or samples of the AI/ML positioning model training data may include two parts: part A and part B. For example, the part A may include at least some of measurement, quality indicator, and timestamp, while the part B may include at least some of label, quality indicator, and timestamp. If a single sample in the process of collecting training data for the AI/ML positioning model includes both the part A and part B, the single sample may be defined as information about the same terminal at the same position, where the content indicated by each parameter is identical. Since entities generating the part A and part B may be different, additional signaling may be introduced to define or configure a linkage between the part A and part B, in addition to the timestamp.

Meanwhile, the data for inference of the AI/ML positioning model may include at least one of timing information and at least one pair of timing and channel response magnitude.

FIG. 13 is a sequence diagram illustrating a data collection configuration request procedure initiated by a gNB.

Referring to FIG. 13, the base station may transmit data collection configuration request information (i.e. DatacollectionConfigRequest IE) to the LMF in step S1310. Here, the example in FIG. 13 may be applied to sidelink positioning. Specifically, the example in FIG. 13 may correspond to a procedure for transmitting the DatacollectionConfigRequest IE between a first endpoint and a second endpoint.

Hereinafter, a method for configuring an UL SRS environment for training data collection is proposed.

A (gNB-initiated) UL SRS environment configuration request message, which is transmitted by the gNB to the LMF, may be newly defined within NRPPa and this message may be utilized to request configuration of an environment for collecting data for AI/ML positioning model training or inference.

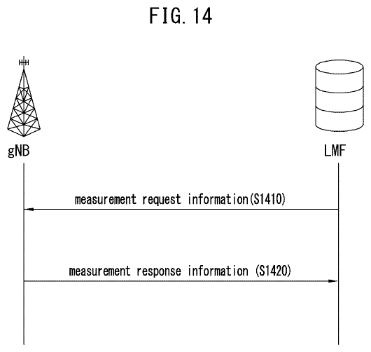

FIG. 14 is a sequence diagram illustrating a measurement request and response procedure.

Here, the example in FIG. 14 may be applied to sidelink positioning. Specifically, the example in FIG. 14 may correspond to a measurement request and response procedure between a first endpoint and a second endpoint.

Referring to FIG. 14, Case 3b represents NG-RAN node-assisted positioning with an LMF-sided model and direct AI/ML positioning. In relation to Case 3b, the AI/ML model is located in the LMF. The gNB (or TRP) may measure UL SRS and transmit CIR/PDP/DP information to the LMF, and then the LMF may estimate the UE's position directly using the received information (through the direct AI/ML positioning model). Among the channel responses, DP requires time information for channel taps, PDP requires both time and magnitude information for the channel taps, and CIR additionally requires phase information for the channel taps. Even when a wireless channel experienced by a signal is a single-tap channel, the wireless channel observable at the receiver may appear across multiple taps (multi-tap) due to a limited bandwidth. When the receiver observes the multi-tap channel, it may be difficult to distinguish multiple paths due to overlapping effects of the channel taps. The receiver may distinguish the multiple paths by performing high-resolution interpolation.

In Case 3b, data collection for model training is performed at the LMF, and the gNB may transmit CIR/PDP/DP measured using UL SRS to the LMF by using NRPPa. As described above, the measured CIR/PDP/DP may be sample-based values or may be path-based values obtained through additional processing. Regarding sample-based values, a basic time unit of a sample may be defined or determined as a specific value. Additionally, a range of samples and the number of reported samples may be defined as at least some of the samples exhibiting high power among all the samples within a time window, rather than all the samples within the time window.

In the case of path-based measurement, time and magnitude information for up to nine paths may be transmitted using the existing NRPPa. As shown in FIG. 14, when the LMF transmits a measurement request (i.e. MEASUREMENT REQUEST) message (or information) to the gNB in step S1410, the gNB may transmit a measurement response (i.e. MEASUREMENT RESPONSE) message (or information) to the LMF in step S1420. Here, the information or message transmitted in step S1410 may be the same as the information transmitted in step S1110 of FIG. 11. Alternatively, the base station may transmit a measurement response or measurement report message to the LMF without a measurement request message. Within these two messages, fields specifying up to nine paths' magnitude (RSRP) and delay values (time delays) may be included in a UL RTOA or gNB Rx-Tx time difference IE.

To transmit sample-based channel responses from the gNB to the LMF, a new IE, for example, gNB channel measurement IE (this IE name is arbitrarily defined), may be included in the measurement response (or measurement report) message. The newly defined IE will be described later.

Hereinafter, a signal for transmitting sample-based measurement values is proposed.

To transmit sample-based channel responses measured by the gNB to the LMF, a newly defined ‘gNB channel measurement IE’ (this IE name is arbitrarily defined and may be changed) may be included in a TRP measurement result IE within the measurement response (or measurement report) message. The newly defined IE may include detailed information on channel response data collected from the gNB and may be utilized in the training or inference process of the AI/ML positioning model.

The following describes an example of the gNB channel measurement IE. T32Q8 refers to an 8-bit quantized magnitude value for each of 32 channel taps. The example described above is merely an example, and other combinations of channel taps and quantization bits may be possible. The tap indication may be expressed as a bitmap indicating the taps corresponding to the transmitted magnitudes among a total of 256 channel taps. When transmitting the magnitudes for all 256 taps, the transmission of the tap indication field may be omitted.

Table 7 illustrates an example of the gNB channel measurement IE.

TABLE 7

| IE/Group Name [symbol] | Presence [symbol] | Range [symbol] | Note [symbol] |
|---|---|---|---|
| gNB Channel | M [symbol] | [symbol] | [symbol] |
| Measurement [symbol] | | | |
| > CHOICE Channel | M [symbol] | [symbol] | [symbol] |
| Magnitude [symbol] | | | |
| >> T32Q8 [symbol] | [symbol] | 32 × 8 bits [symbol] | [symbol] |
| >> T32Q16 [symbol] | [symbol] | 32 × 16 bits [symbol] | [symbol] |
| >> T64Q8 [symbol] | [symbol] | [symbol] | [symbol] |
| >> T64Q16 [symbol] | [symbol] | [symbol] | [symbol] |
| >> T128Q8 [symbol] | [symbol] | [symbol] | [symbol] |
| >> T128Q16 [symbol] | [symbol] | [symbol] | [symbol] |
| >> T256Q8 [symbol] | [symbol] | [symbol] | [symbol] |
| >> T256Q16 [symbol] | [symbol] | 256 × 16 bits [symbol] | [symbol] |
| > Tap indication [symbol] | O [symbol] | 256 bits [symbol] | Exists except |
| | | | for T256Q8 |
| | | | and T256Q16 [symbol] |

Hereinafter, monitoring of the model performance for direct AI/ML positioning is described.

The performance monitoring of an AI/ML positioning model may be categorized into label-based and label-free methods. The label-based performance monitoring method has the disadvantage of difficulty in obtaining labels but allows for easy derivation of monitoring metrics such as an average or maximum error between model outputs and the labels. In contrast, the label-free method monitors model performance using statistical properties of model inputs or outputs and enables performance monitoring without labels.

Hereinafter, a label-free model performance monitoring method proposed in the present disclosure for a direct AI/ML positioning model will be described.

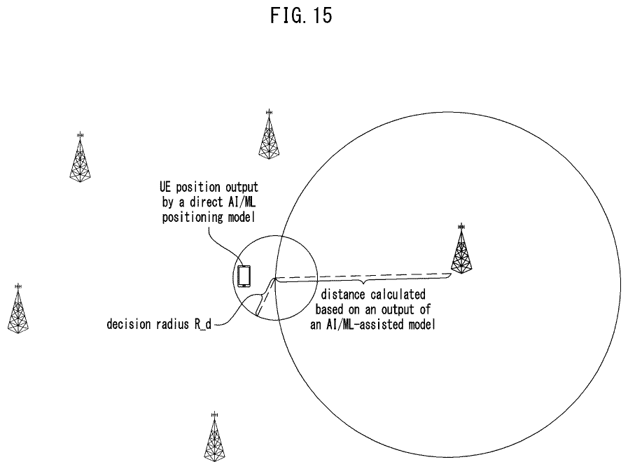

FIG. 15 is a conceptual diagram illustrating a label-free performance monitoring method for a direct AI/ML positioning model.

Referring to FIG. 15, a direct AI/ML positioning model performance monitoring method is proposed.

For example, a monitoring entity for a direct AI/ML positioning model may obtain both outputs of the direct AI/ML positioning model and outputs of an AI/ML-assisted positioning model. Inputs of both positioning models may be channel responses between multiple TRPs and a target UE. The outputs of the direct AI/ML positioning model may be the UE's position, while the outputs of the AI/ML-assisted positioning model may be a time of arrival (ToA) and a confidence level of the output.

If model monitoring is determined to be necessary, the monitoring entity may use (1) the UE's position values output by the direct AI/ML positioning model and (2) the ToA of a TRP with the highest confidence level among the outputs of the AI/ML-assisted positioning model. In the case of (2), for an LOS link, a distance between the TRP and the UE may be derived. Even in an NLOS link, the distance between the TRP and the UE may be derived by assuming a virtual LOS link.

For example, the monitoring method may be applied only when the output confidence level of the AI/ML-assisted positioning model is greater than a confidence threshold Th_confidence. If the output confidence level of the AI/ML-assisted positioning model does not exceed the confidence threshold Th_confidence, the monitoring entity may not perform monitoring and perform monitoring in the next measurement opportunity. Through this approach, model monitoring may be performed only when the confidence level of the AI/ML-assisted positioning model is sufficiently high, ensuring the accuracy of model monitoring. The confidence threshold Th_confidence may be set as a design parameter and may be adjusted to establish a reference for the confidence level of the model. The confidence threshold may be determined by the network and indicated to the monitoring entity, or it may be predefined as a fixed value.

If the output confidence level of the AI/ML-assisted positioning model is greater than the confidence threshold Th_confidence, the monitoring entity may draw an extended line between (1) the UE's position and (2) the TRP's position, and draw a circle by calculating a radius from the TRP using the ToA value of the TRP. Then, the monitoring entity may determine that the performance of the direct AI/ML positioning model is satisfactory if the UE's position is located within a circle (hereinafter referred to as ‘decision circle’) with a radius equal to a decision radius R_d from an intersection of the extended line and the previously drawn circle. Otherwise, the monitoring entity may determine that the model has a performance issue. The decision radius R_d is a design parameter. In other words, the decision radius may serve as a criterion or performance threshold for determining whether the direct AI/ML positioning model meets the required performance.

If the output confidence level of the AI/ML-assisted positioning model is greater than the confidence threshold Th_confidence, the monitoring entity may operate according to the following steps:
Monitoring Step 1: Draw an extended line between (1) the UE's position output by the direct AI/ML positioning model and (2) the TRP's position.
Monitoring Step 2: Using the ToA value of the TRP, calculate a radius from the TRP and draw the corresponding circle.
Monitoring Step 3: From the intersection of the extended line and the circle, draw a decision circle with a radius equal to the decision radius R_d. If the UE's position (1) is located within the decision circle, the performance of the direct AI/ML positioning model may be determined to be satisfactory. Otherwise, the model performance may be determined to have an issue.

Here, the model performance evaluation scheme may be adjusted by modifying the decision radius R_d. The model monitoring method is illustrated in FIG. 15.

As another example, when it is determined that model monitoring is necessary, the monitoring entity may perform model monitoring using (1) the UE's position, which is the direct output of the AI/ML positioning model, (2) LOS/NLOS soft indicators of the AI/ML-assisted positioning model (e.g. a value of each soft indicator may provide a probability of an LOS propagation path, which ranges between 0 and 1 with a resolution of 0.1, a value of ‘0’ indicating NLOS, and a value of ‘1’ indicating LOS), and (3) timing information obtained from a conventional positioning method. Here, the monitoring entity may use (2) the LOS/NLOS soft indicator of the AI/ML-assisted positioning model and may replace the ToA value of the AI/ML-assisted positioning model with the timing information from the conventional positioning method. Specifically, among the LOS/NLOS soft indicators of the AI/ML assisted positioning model, timing information of a link with the highest value greater than the confidence threshold may be used for monitoring. Subsequent operations may be applied in the same manner.

As yet another example, the model performance monitoring method may be performed by accumulating calculation results over a certain period. The model performance monitoring entity may calculate the following metric over the certain period:

$$Metric = ( a ) * ( c ) / {( b )}^{2} ,$$

where (a) to (c) are defined as follows.
(a) The number of monitoring attempts
(b) The number of instances where the AI/ML-assisted positioning model output exhibited a confidence level greater than the confidence threshold Th_confidence
(c) The number of failures to satisfy the performance monitoring

After calculating the monitoring metric over the certain period, if the calculated value exceeds a monitoring decision value D_monitor, the monitoring entity may determine that there is a problem in the use of the direct AI/ML model and may attempt model switching or model deactivation. Here, (1) the time period for calculating the metric and (2) the monitoring decision value D_monitor are design parameters.

Here, the monitoring entity may perform monitoring based on information regarding a value of D_monitor received from the network or based on a predetermined value of D_monitor. Additionally, the period for calculating the monitoring metric may be determined by the network and indicated to the monitoring entity or may have a predetermined value.

As an example, if the result of performance monitoring indicates that the value of (a)*(c)/(b)² is greater than the value of D_monitor, the monitoring entity may determine to change the AI/ML model or deactivate the AI/ML model and revert to the conventional positioning method. In this case, the monitoring entity may request the network to change the AI/ML model, receive a new AI/ML model from the network, request a dataset for retraining the existing AI/ML model, perform model training using an internally stored dataset, or use a stored new AI/ML model. Here, the new AI/ML model may be a model of a different type from the existing AI/ML model or an updated version of the existing AI/ML model. If no suitable AI/ML model is available, the system may revert to the conventional positioning method that does not use AI/ML.

In other words, as an example of the aforementioned performance monitoring method, a device performing performance monitoring may obtain a first output result of the direct AI/ML positioning model, a second output result of the AI/ML-assisted positioning model, and a positioning result based on a non-AI/ML model. The device may perform monitoring of the performance of the direct AI/ML positioning model using at least one of the first output result, the second output result, and the positioning result based on the non-AI/ML model.

Here, as described above, the first output result may be a position of the positioning target, and the second output result may be a ToA between the positioning target and a specific TRP and a confidence level of the ToA. Additionally, when a circle is defined using a distance calculated based on the ToA of the specific TRP with the highest confidence level among TRPs whose confidence level is greater than the confidence threshold as a radius and using the position of the specific TRP as a center, if the shortest distance between the position of the positioning target according to the first output result and the circle is smaller than the performance threshold, the device may determine that the performance of the direct AI/ML positioning model is normal. Furthermore, when the circle is defined using the distance calculated based on the ToA of the specific TRP with the highest confidence level among TRPs whose confidence level is greater than the confidence threshold as the radius and the position of the specific TRP as the center, if the shortest distance between the position of the positioning target according to the first output result and the circle is greater than the performance threshold, the device may determine that the performance of the direct AI/ML positioning model is abnormal. Additionally, the second output result may be an LOS/NLOS soft indicator, and the positioning result based on the non-AI/ML model may be a ToA between the positioning target and the specific TRP. The LOS/NLOS soft indicator may have a value in a range from 0, indicating NLOS, to 1, indicating LOS, and may serve as an indicator representing a probability of an LOS propagation path. Furthermore, when a circle is defined using a distance calculated using the ToA of the specific TRP corresponding to an LOS/NLOS soft indicator with the highest value as a radius and the position of the specific TRP as a center, if the shortest distance between the position of the positioning target according to the first output result and the circle is smaller than the performance threshold, the device may determine that the performance of the direct AI/ML positioning model is normal. If the shortest distance between the position of the positioning target according to the first output result and the circle is greater than the performance threshold, the device may determine that the performance of the direct AI/ML positioning model is abnormal. Moreover, the performance of the direct AI/ML positioning model may be adjusted through the control of the performance threshold.

The present disclosure may provide new information elements (IE) and signaling methods or direct AI/ML positioning model performance monitoring methods for utilizing AI/ML positioning technology.

Hereinafter, an example of a communication system to which the present disclosure is applied will be described.

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

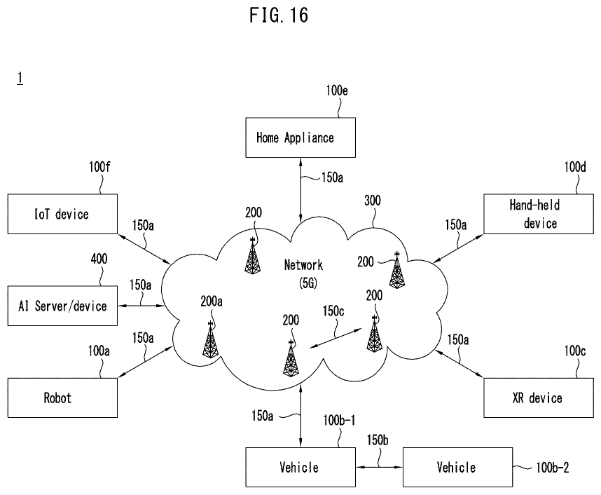

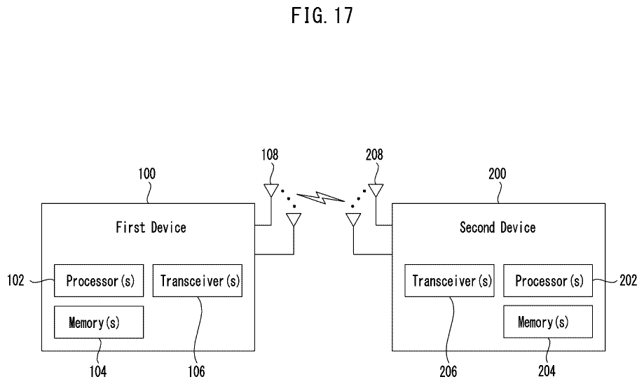

FIG. 16 illustrates a communication system applicable to the present disclosure.

Referring to FIG. 16, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, the wireless communication technology implemented in the wireless device of the present disclosure may include not only LTE, NR, and 6G but also Narrowband Internet of Things (NB-IoT) for low-power communication. In this case, for example, NB-IoT technology may be an example of Low Power Wide Area Network (LPWAN) technology and may be implemented according to standards such as LTE Cat NB1 and/or LTE Cat NB2, without being limited to the aforementioned names. Additionally or alternatively, the wireless communication technology implemented in the wireless device of the present disclosure may perform communication based on LTE-M technology. In this case, for example, LTE-M technology may be an example of LPWAN technology and may be referred to by various names such as enhanced Machine Type Communication (eMTC). For example, LTE-M technology may be implemented according to at least one of the following standards: 1) LTE Cat 0, 2) LTE Cat M1, 3) LTE Cat M2, 4) LTE non-Bandwidth Limited (non-BL), 5) LTE-MTC, 6) LTE Machine Type Communication, and/or 7) LTE M, without being limited to the aforementioned names. Additionally or alternatively, the wireless communication technology implemented in the wireless device of the present disclosure may include at least one of ZigBee, Bluetooth, and Low Power Wide Area Network (LPWAN), considering low-power communication, without being limited to the aforementioned names. For example, ZigBee technology may create personal area networks (PAN) related to small-scale/low-power digital communication based on various standards such as IEEE 802.15.4 and may be referred to by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 17 illustrates a wireless device applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control SO that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Various exemplary embodiments of the present disclosure may be implemented through hardware, firmware, software, or a combination thereof. In the case of hardware implementation, the various exemplary embodiments of the present disclosure may be implemented using one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general processors, controllers, microcontrollers, or microprocessors.

The scope of the present disclosure includes software or machine-executable instructions (e.g. operating systems, applications, firmware, programs, etc.) that allow operations according to the methods of various exemplary embodiments to be executed on a device or computer, as well as non-transitory computer-readable media in which such software or instructions are stored and executable on a device or computer. Examples of computer-readable media include hardware devices specifically configured to store and execute program instructions, such as ROM, RAM, and flash memory. Examples of program instructions include not only machine code generated by a compiler but also high-level language code that can be executed by a computer using an interpreter or similar methods. The aforementioned hardware devices may be configured to operate as at least one software module to perform the operations of the present disclosure, and vice versa.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method performed by a communication device in a wireless communication system, comprising:
receiving capability request information for artificial intelligence/machine learning (AI/ML)-based positioning from a network; and
transmitting capability information based on the capability request information,
wherein the capability information includes at least one of first information indicating whether the communication device supports AI/ML direct positioning, second information indicating whether the communication device supports AI/ML-assisted positioning, and third information indicating a type of a channel report related to the AI/ML-based positioning.

2. The method according to claim 1, wherein each of the first information and the second information is configured as boolean data, and the third information indicates at least one of a channel impulse response (CIR), a delay profile (DP), a power delay profile (PDP), or a sample-based measurement related parameter.

3. The method according to claim 1, wherein the capability information is transmitted to a location management function (LMF).

4. A method performed by a communication device in a wireless communication system, comprising:
obtaining a first output result of a direct AI/ML positioning model, a second output result of an AI/ML-assisted positioning model, and a non-AI/ML model-based positioning result; and
monitoring a performance of the direct AI/ML positioning model by using at least one of the first output result, the second output result, and the non-AI/ML model-based positioning result.

5. The method according to claim 4, wherein the first output result indicates a position of a positioning target, and the second output result indicates a time of arrival (ToA) between the positioning target and a specific transmission/reception point (TRP) and a confidence level of the ToA.

6. The method according to claim 5, wherein a circle is assumed with a radius, which is a distance calculated based on an arrival time of the specific TRP having a highest confidence level among TRPs having confidence level greater than a confidence threshold, and a center, which is a position of the specific TRP, and the performance of the direct AI/ML positioning model is determined to be normal when a shortest distance between the position of the positioning target according to the first output result and the circle is smaller than a performance threshold.

7. The method according to claim 5, wherein a circle is assumed with a radius, which is a distance calculated based on an arrival time of the specific TRP having a highest confidence level among TRPs having confidence level greater than a confidence threshold, and a center, which is a position of the specific TRP, and the performance of the direct AI/ML positioning model is determined to be abnormal when a shortest distance between the position of the positioning target according to the first output result and the circle is greater than a performance threshold.

8. The method according to claim 4, wherein the second output result is a Line of Sight (LOS)/Non-Line of Sight (NLOS) soft indicator, and the non-AI/ML model-based positioning result is a time of arrival (ToA) between the positioning target and the specific TRP.

9. The method according to claim 8, wherein the LOS/NLOS soft indicator has a value ranging from 0 indicating NLOS to 1 indicating LOS, and is an indicator indicating a possibility of an LOS propagation path.

10. The method according to claim 8, wherein a circle is assumed with a radius, which is a distance calculated based on an arrival time of the specific TRP corresponding to a highest LOS/NLOS soft indicator, and a center, which is a position of the specific TRP, the performance of the direct AI/ML positioning model is determined to be normal when a shortest distance between the position of the positioning target according to the first output result and the circle is smaller than a performance threshold, and the performance of the direct AI/ML positioning model is determined to be abnormal when the shortest distance between the position of the positioning target according to the first output result and the circle is greater than the performance threshold.

11. The method according to claim 6, wherein the performance of the direct AI/ML positioning model is adjusted through control of the performance threshold.

12. A communication device comprising:
at least one memory storing commands;
at least one transceiver; and
at least one processor connected to the at least one memory and the at least one transceiver,
wherein the at least one processor executes the commands to perform:
receiving capability request information for artificial intelligence/machine learning (AI/ML)-based positioning from a network; and
transmitting capability information based on the capability request information,
wherein the capability information includes at least one of first information indicating whether the communication device supports AI/ML direct positioning, second information indicating whether the communication device supports AI/ML-assisted positioning, and third information indicating a type of a channel report related to the AI/ML-based positioning.

13. The communication device according to claim 12, wherein each of the first information and the second information is configured as boolean data, and the third information indicates at least one of a channel impulse response (CIR), a delay profile (DP), a power delay profile (PDP), or a sample-based measurement related parameter.

14. The communication device according to claim 12, wherein the capability information is transmitted to a location management function (LMF).
